(19) United States
(12) Patent Application Publication
(10) Pub. No.: US 2007/0090964 A1
(43) Pub. Date: Apr. 26, 2007

(54) INDICATING CIRCUIT FOR COMPUTER

(75) Inventors: Yong-Xing You, Shenzhen (CN); Ke-You Hu, Shenzhen (CN); Xiang Cao, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,113

(22) Filed: Jun. 23, 2006

(30) Foreign Application Priority Data
Oct. 26, 2005 (CN) 200510100779.5

(51) Int. Cl. G09F 9/33; G08B 21/00; G08B 5/22

(52) U.S. Cl. 340/815.45; 340/654; 340/540

(57) ABSTRACT

In one preferred embodiment, an indicating circuit for a computer includes a microcontroller receiving a plurality of signals from the computer, and transforming the signals into a plurality of control signals; and an indicator having at least two light-emitting diodes (LEDs), and controlled by the control signals, wherein the at least two LEDs have different colors. The at least two LEDs emit lights of various colors according to the various usage states of hard disk, or power states of the computer. So it is easy for users to see the states of the computer.

### FIELD OF THE INVENTION

The present invention relates to the field of indicator circuits for computers, and particularly to a circuit for indicating computer states.

### DESCRIPTION OF RELATED ART

Typical computers employ a single color light-emitting diode (LED) as an indicator to indicate computer states. A flashing frequency of the LED indicates a state of the computer. For example, the flashing frequency may indicate how intensely the high-density disk (HDD) is working, the faster the flashing the harder the HDD is working.

However, if ambient light is too bright, it is difficult to see the LED clearly. Sometimes users must be quite close to the LED to see it clearly. Thus, the function of the indicator is not user-friendly.

What is desired, therefore, is an indicating circuit for a computer which is user-friendly.

### SUMMARY OF THE INVENTION

In one preferred embodiment, an indicating circuit for a computer includes a microcontroller receiving a plurality of signals, and transforming the signals into a plurality of control signals; and an indicator with at least two light-emitting diodes (LEDs), and controlled by the control signals, wherein the two LEDs are different colors.

Other advantages and novel features will become more apparent from the following detailed description of preferred embodiments when taken in conjunction with the accompanying drawings, in which:

### BRIEF DESCRIPTION OF THE DRAWINGS

FIG. 1 is a circuit diagram of an indicating circuit for a computer of a preferred embodiment of the present invention.

### DETAILED DESCRIPTION OF THE INVENTION

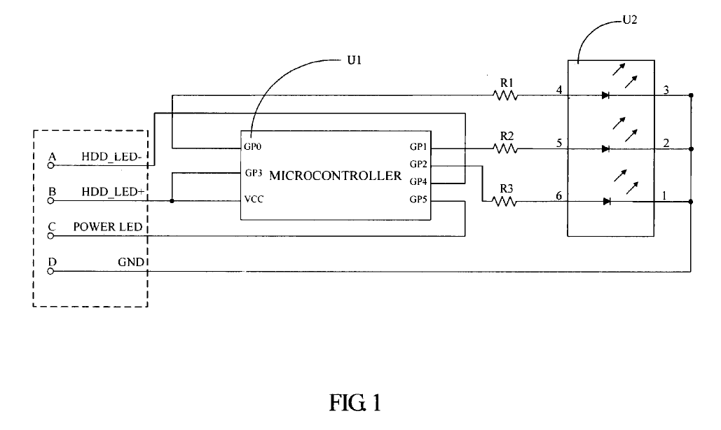

As shown in FIG. 1, in a preferred embodiment of the present invention, an indicating circuit for a computer includes a microcontroller U1, an indicator U2 controlled by the microcontroller Ul, and resistors R1, R2, and R3.

In the preferred embodiment, the microcontroller U1 employs an 8-pin flash -based 8-bit CMOS microcontroller made by the Microchip Technology Inc., coded PIC12F675. Base parameters of the PIC12F675 microcontroller are shown in the following table 1. The indicator U2 employs a full color LED lamp made by the Kingbright Company, coded AAF5060PBESEEVG. Base parameters of the AAF5060PBESEEVG full color LED lamp are shown in the following table 2.

TABLE 1
Parameters of PIC12F675 microcontroller

| Parameter | Specification |
|---|---|
| Pins and Package | 8-Pins/Dual In-line Package |
| Timer | 20 MHZ |
| Flash (words) | 1024 |
| SRAM (bytes) | 64 |
| EEPROM (bytes) | 128 |
| I/O ports | 6 |
| Analog/Digital converter (channel) | 4 |
| Comparators | 1 |

TABLE 2
Parameters of AAF5060PBESEEVG full color LED lamp

| Parameter | Specification |
|---|---|
| Size | 5.0 mm × 6.0 mm |
| Colors | Blue/Hyper Orange/Green |
| Dominant Wavelength | 470 nm/621 nm/525 nm |
| Viewing Angle | 100° |

The indicator U2 has three high bright LEDs, including a blue LED, a hyper orange LED, and a green LED. Anodes of the blue LED, the hyper orange LED, and the green LED are respectively connected to a pin 4, a pin 5, and a pin 6 of the indicator U2. Cathodes of the blue LED, the hyper orange LED, and the green LED are respectively connected to a pin 3, a pin 2, and a pin 1 of the indicator U2.

An output pin GPO of the microcontroller U1 is coupled to the pin 4 of the indicator U2 via a resistor R1. An output pin GP1 of the microcontroller U1 is coupled to the pin 5 of the indicator U2 via a resistor R2. An output pin GP2 of the microcontroller U1 is coupled to the pin 6 of the indicator U2 via a resistor R3. A pin 4 of the microcontroller U1 receives a signal HDD_LED− from a motherboard via a first port A. The signal HDD_LED− is a clock pulse for indicating a state of a hard disk. A pin 3 and a pin VCC of the microcontroller U1 receive a reference signal of constant voltage HDD_LED+ via a second port B. A pin GP5 of the microcontroller U1 receives a signal POWER_LED from the motherboard via a third port C indicating a power status of the computer. The pins 1, 2, and 3 of the indicator U2 are grounded via a forth port D.

In operation, the microcontroller U1 transforms the signal HDD-LED− into a plurality of control signals. The control signals are sent to the indicator U2 respectively via the pins GP0, GP1, and GP2. An apparent color of the indicator U2 is controlled by varying the percentage of on time for each of the LEDs by varying a frequency of flashing of the LEDs. The frequencies used are fast enough that the indicator U2 will appear to be continuously lit, but the color will vary accordingly. The control signals are 8-bit binary numbers. An appropriate control signal is sent to each LED setting the desired frequency, thus producing a desired color viewable by a user. A wide range of apparent colors is available by mixing the on times of the LEDs and each color may be used for indicating a different state of the computer. For example, if the hard disk is under intense use, the signal HDD_LED− is high and causes control signals to be sent to the LEDs that produce a dark blue light, and conversely if the hard disk is only under light use, the signal HDD_LED− is low causing control signals to be sent to the LEDs that produce a yellow light.

On the same time, the microcontroller U1 receives the signal POWER_LED so that the indicating circuit is also used for showing power states of the computer.

It is believed that the present embodiment and its advantages will be understood from the foregoing description, and it will be apparent that various changes may be made thereto without departing from the spirit and scope of the invention or sacrificing all of its material advantages, the example hereinbefore described merely being a preferred or exemplary embodiment.

What is claimed is:

1. An indicating circuit for a computer, comprising:
a microcontroller receiving a plurality of signals from the computer, and transforming the signals into a plurality of control signals; and
an indicator having at least two light-emitting diodes (LEDs), and controlled by the control signals, wherein the at least two LEDs have different colors.

2. The indicating circuit as claimed in claim 1, wherein the signals comprise a signal indicating usage states of a hard disk.

3. The indicating circuit as claimed in claim 1, wherein the signals comprise a signal indicating power states of the computer.

4. The indicating circuit as claimed in claim 1, further comprising a resistor for each of the at least two LEDs, wherein the control signals from the microcontroller are sent to the at least two LEDs via the corresponding resistor.

5. The indicating circuit as claimed in claim 1, wherein the at least two LEDs are high bright LEDs.

6. The indicating circuit as claimed in claim 1, wherein the at least two LEDs comprise three LEDs, the three LEDs respectively have different colors, blue, hyper orange, and green.

7. The indicating circuit as claimed in claim 6, wherein each of the control signals are 8-bit binary numbers, the 8-bit binary numbers for controlling on times of the three LEDs.

8. An indicating circuit for a computer, comprising:
a microcontroller receiving a signal from the computer, and transforming the signal into a plurality of control signals; and
an indicator having at least two light-emitting diode (LED), and controlled by the control signals, wherein the at least two LEDs having different colors are controlled by the signal to emit various colors light.

9. The indicating circuit as claimed in claim 8, wherein the signal is a signal indicating usage states of a hard disk.

10. The indicating circuit as claimed in claim 8, wherein the signal is a signal indicating power states of the computer.

11. The indicating circuit as claimed in claim 8, wherein further comprising a resistor for each of the at least two LEDs, wherein the control signals from the microcontroller are sent to the at least two LEDs via the corresponding resistor.

12. The indicating circuit as claimed in claim 8, wherein the at least two LEDs are high bright LEDs.

13. The indicating circuit as claimed in claim 8, wherein the LEDs comprise three LEDs, the three LEDs respectively have different colors, the colors comprises blue, hyper orange, and green.

14. The indicating circuit as claimed in claim 8, wherein each of the control signals are 8-bit binary numbers, the 8-bit binary numbers for controlling on times of the three LEDs.
